(19) United States
(12) Patent Application Publication
(10) Pub. No.: US 2024/0332732 A1
(43) Pub. Date: Oct. 3, 2024

(54) LITHIUM BATTERY SEPARATOR AND LITHIUM BATTERY

(71) Applicant: SHENZHEN CAPCHEM TECHNOLOGY CO., LTD., SHENZHEN, GUANGDONG (CN)

(72) Inventors: ZHONGBO LIU, SHENZHEN (CN); YONGHONG DENG, SHENZHEN (CN); HONGLI XU, SHENZHEN (CN); XIAOHU AO, SHENZHEN (CN); ZHONGTIAN ZHENG, SHENZHEN (CN)

(21) Appl. No.: 18/741,803

(22) Filed: Jun. 13, 2024

Related U.S. Application Data
(63) Continuation of application No. PCT/CN2022/138382, filed on Dec. 12, 2022.

(30) Foreign Application Priority Data
Dec. 14, 2021 (CN) 202111528156.3

(51) Int. Cl. H01M 50/414; H01M 10/0525; H01M 10/0567; H01M 50/449; H01M 50/491

(52) U.S. Cl. CPC H01M 50/414; H01M 10/0525; H01M 10/0567; H01M 50/449; H01M 50/491; H01M 2300/0025

(57) ABSTRACT

The present invention relates to the technical field of lithium batteries, and in particular, to a lithium battery separator and a lithium battery. The separator comprises a block polymer, the porosity of the separator is p, the mass percentage of the block polymer relative to the separator is w, and the relationship between the porosity p of the separator and the relative mass percentage w of the block polymer satisfies that (1−w)/3<p<25%. According to the lithium battery separator of the present invention, the block polymer is added, such that the separator also achieves the functions of the separator itself under the condition of a relatively small porosity, has good lithium-ion conduction characteristics, can reduce the thermal shrinkage rate thereof, and improves the safety performance.

### TECHNICAL FIELD

The present invention relates to the technical field of lithium batteries, and in particular to a lithium battery separator and a lithium battery.

### BACKGROUND

In the structure of a lithium battery, a separator is one of the most critical inner-layer components. At present, the separator of a commercial lithium battery is mainly a porous polyolefin separator, wherein the porous separator plays a role in blocking the contact of positive and negative electrodes, and an electrolyte occupies pores in the separator to provide a lithium ion transmission channel. In order to achieve a higher ionic conductivity, the porosity of the separator is usually controlled to be 50% or above. When a battery is in thermal runaway, a conventional separator shrinks along with the rise of temperature, and the separator shrinks significantly when the temperature reaches 120° C. or higher. The shrinkage of the separator may cause direct contact between positive and negative electrodes, which leads to the acceleration of thermal runaway of the battery, and eventually leads to a safety problem.

Most of the existing separators are coated with ceramic material, polymer material or other materials to improve the safety characteristics of the separators, and this method can increase the thermal shrinkage temperature of the separators and reduce the shrinkage rate to a certain extent. However, such a method improves the processing difficulty and cost of the separator and reduces the energy density of the battery, but cannot solve the problem of thermal shrinkage of a polyolefin body thoroughly.

### SUMMARY

Aiming at the problems of thermal shrinkage of a separator and performance improvement of a lithium battery, the present invention provides a lithium battery separator and a lithium battery.

The technical solutions adopted by the present invention are as follows:

In one aspect, the present invention provides a lithium battery separator, wherein the separator contains a block polymer, a porosity of the separator is p, a mass percentage of the block polymer relative to the separator is w, and a relationship between the porosity p of the separator and the mass percentage w of the block polymer relative to the separator satisfies that (1−w)/3<p<25%.

Further, the mass percentage w of the block polymer relative to the separator is >40%.

The addition of the block polymer may effectively improve the ionic conductivity of the separator body, and thus the separator has a high ionic conductivity under the condition of a low porosity, and the same conductivity characteristic can be achieved by requiring a high porosity when the content of the block polymer is low; a high conductivity can also be achieved at a low porosity when the content of the block polymer is high. The separator has a high conductivity when the content of the block polymer and the porosity of the separator satisfy that (1−w)/3<p. As the higher the porosity of the separator is, the greater the thermal shrinkage of the separator is, and the greater the possibility of safety problems is, the porosity p of the separator in the present invention is <25%.

Further, the block polymer comprises a flexible block A and a rigid block B, a structure of the block polymer is AₙBₘ, AₙBₘAₙ, or BₘAₙBₘ, a weight average molecular weight Wₐ of the flexible block A satisfies that 8≤Wₐ≤100 in unit of ten thousand, and a weight average molecular weight W_{b} of the rigid block B satisfies that 10≤W_{b}≤150 in unit of ten thousand. Preferably, the weight average molecular weight Wₐ of the flexible block A satisfies that 12≤Wₐ≤50, and the weight average molecular weight W_{b} of the rigid block B satisfies that 15≤W_{b}≤70.

According to the present invention, a block polymer at least comprising a flexible block and a rigid block is added into the separator, wherein the flexible block A has certain lithium ion conduction characteristics, and may adsorb a certain electrolyte in the presence of the electrolyte, such that the separator itself has the lithium-ion conduction characteristics, and thus the requirement of ion transmission can be satisfied under the condition of a low porosity; meanwhile, the addition of the rigid block B having high mechanical strength enables the separator itself to have good tensile strength.

Further, the weight average molecular weight Wₐ of the flexible block A and the weight average molecular weight W_{b} of the rigid block B satisfy that 0.25≤Wₐ/W_{b}≤5. Preferably, the weight average molecular weight Wₐ of the flexible block A and the weight average molecular weight W_{b} of the rigid block B satisfy that 0.5≤Wₐ/W_{b}≤3.

Further, a thickness d of the separator satisfies that 3≤d≤20 in unit of μm; preferably, the thickness d of the separator satisfies that 4≤d≤10. The weight average molecular weight Wₐ of the flexible block A and the thickness d of the separator satisfy that 3≤Wₐ/d≤25; preferably, the weight average molecular weight Wₐ of the flexible block A and the thickness d of the separator satisfy that 4≤Wₐ/d≤20.

The molecular structure AₙBₘ, AₙBₘAₙ, or BₘAₙBₘ of the block polymer may cause high molecules to be present in the separator in a phase-separated form, wherein the dimension of A and B phases is associated with the molecular weight. When the phase-separated structure of the block A just forms a continuous conduction network in the separator, and meanwhile, a continuous phase with a large area may not be formed, the separator has both high ionic conductivity and mechanical strength. The inventors have confirmed through a series of experiments that the conductivity and the mechanical strength of the separator are optimal when the weight average molecular weight Wₐ of the block A and the thickness d of the separator satisfy that 4≤Wₐ/d≤20.

Further, a structural formula of the flexible block A is as follows:

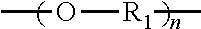

wherein R₁ is hydrocarbyl having a degree of unsaturation of not more than 1, and a molecular weight W₁ of R₁ satisfies that 28≤W₁≤108; specifically, R₁ is any one of —(CH₂)₂—, —(CH₂)₃—, —(CH₂)₄—, —(CH₂)₅—, —(CH₂)₆—, —(CH₂)₇—,

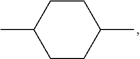

—CH═CH—CH₂—, —CH═CH—(CH₂)₂—, —CH═CH—(CH₂)₃—, —CH═CH—(CH₂)₄—, and —CH═CH—(CH₂)₅—.

a structural formula of the rigid block B is as follows:

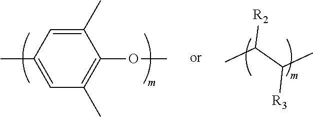

wherein R₂ is one of hydrogen, hydrocarbyl or halohydrocarbyl having a molecular weight of not more than 45, and a saturated ester group;
R₃ is one of hydrogen, hydrocarbyl or halohydrocarbyl having a molecular weight of not more than 45, cyclic unsaturated hydrocarbyl, and aliphatic hydrocarbyl.

The rigid block B is selected from any one of the following structures:

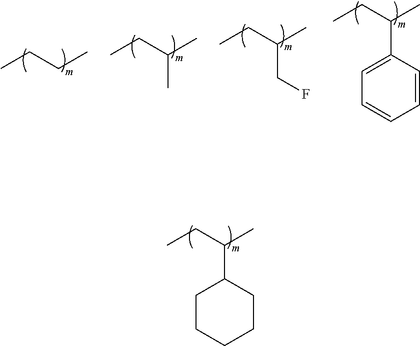

In some embodiments of the present invention, the rigid block B is selected from any one of the following structures:

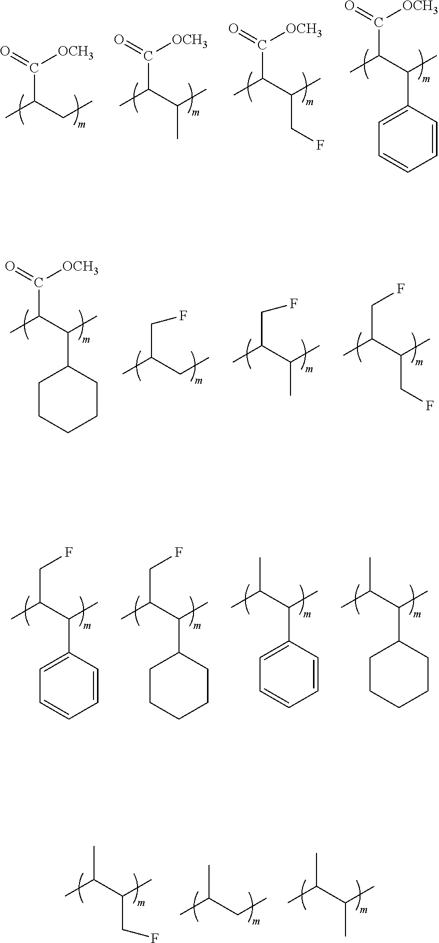

Specifically, the preparation method for the block polymer may adopt a segmented polymerization mode, firstly, the flexible block A is prepared by using a conventional synthesis method in the polymer field such as free radical polymerization and polycondensation, the molecular weight of the flexible block A is controlled by controlling the amount of an initiator, the amount of a monomer, etc., the flexible block A is then subjected to terminal group modification and other methods, and the preparation of other blocks is initiated by means of the terminal group modification, thereby preparing a multi-block polymer. The preparation of the block polymer of the present invention is not limited to this method, but also includes other preparation methods for block polymers in the polymer field, and all of them can prepare the block polymer of the present invention.

Specifically, the separator may further comprise a porous base material. The porous base material is a thermoplastic resin having a melting point of 200° C. or lower; more specifically, the porous base material is a polyolefin porous base material. Preferably, the polyolefin porous base material comprises polyethylene, polypropylene, an ethylene copolymer, a propylene copolymer, and a mixture of any combination thereof.

Specifically, the surface of the separator may be further coated with ceramic powder or polymer glue, the ceramic powder comprises one or more of aluminum oxide and boehmite; the polymer glue comprises one or more of PVDF, PMMA, and PAN.

The lithium battery separator may be prepared by adopting a dry method or a wet method. The dry (unidirectional) stretching process is to prepare a highly-oriented multilayer structure having low crystallinity by using a method for producing hard elastic fibers, and then to acquire an oriented film having high crystallinity by means of high-temperature annealing. This film is stretched at a low temperature to form micro defects such as crazes, and then the defects are pulled apart at a high temperature to form micropores. Specifically, in some embodiments of the present invention, the block polymer and other main materials of the lithium battery separator, such as polyolefin resin, are melted, extruded, and blown into a crystalline polymer film, which is crystallized and annealed to obtain a highly-oriented multilayer structure, which is further stretched at a high temperature to peel off the crystal interface to form a porous structure.

The wet method is also called a phase separation method or a thermally induced phase separation method, and comprises adding high-boiling-point small molecules as a porogen into polyolefin, heating the mixture to melt into a homogeneous system, then cooling to carry out phase separation, stretching and extracting with an organic solvent to obtain small molecules to prepare an interpenetrating microporous film material. Specifically, in some embodiments of the present invention, liquid alkane or some small molecular substances are mixed with a block polymer or other main materials such as polyolefin resin, and after heating and melting, a uniform mixture is formed, and then the mixture is cooled to carry out phase separation, and compressed into a membrane, the membrane is then heated to a temperature close to the melting point, and is subjected to biaxial stretching to orient molecular chains, and finally, the temperature is kept for a certain time, and the residual solvent is eluted by volatile substances, thereby preparing an interpenetrating microporous film material.

The test method for the porosity of the separator refers to Standard No. GB/T21650. 2-2008 “Pore size distribution and porosity of solid materials by mercury porosimetry and gas adsorption—Part 2: Analysis of mesopores and macropores by gas adsorption”, and the testing is carried out by mercury porosimetry.

In another aspect, the present invention further provides a lithium battery comprising a positive electrode, a negative electrode, an electrolyte, and the separator as described above.

Further, the electrolyte comprises a cyclic carbonate.

Further, the mass percentage u of the cyclic carbonate relative to the electrolyte is >15%; the cyclic carbonate is selected from any one of ethylene carbonate, propylene carbonate, fluoroethylene carbonate, vinylene carbonate, and difluoroethylene carbonate.

The separator having a low porosity is matched with the electrolyte containing the cyclic carbonate, which is beneficial to achieving low shrinkage of the separator and high conductivity after the electrolyte is swelled. Specifically, the dielectric constant of the cyclic carbonate is high, and the higher the content of the cyclic carbonate in the electrolyte is, the higher the intrinsic ionic conductivity of the electrolyte is, and meanwhile, the swelling characteristic of the electrolyte in the block polymer A can be improved, and thus the ionic conductivity of the separator is further improved; when the content of the cyclic carbonate is too low, the intrinsic conductivity of the electrolyte is too low, resulting in a decrease in the conductivity of the separator.

Specifically, the electrolyte further comprises a solvent and a lithium salt. Preferably, the lithium salt is selected from at least one of LiPF₆, LiBOB, LiDFOB, LiPO₂F₂, LiBF₄, LiSbF₆, LiAsF₆, LiN(SO₂CF₃)₂, LiN(SO₂C₂F₅)₂, LiC(SO₂CF₃)₃, LiN(SO₂F)₂, and LiBETI.

Preferably, the solvent includes one or more of an ether solvent, a nitrile solvent, a carbonate solvent, and a carboxylate solvent.

In some embodiments, the ether solvent comprises a cyclic ether or a chain ether, and the cyclic ether may specifically be, but is not limited to, one or more of 1,3-dioxolane (DOL), 1,4-dioxane (DX), a crown ether, tetrahydrofuran (THF), 2-methyltetrahydrofuran (2-CH3-THF), and 2-trifluoromethyltetrahydrofuran (2-CF3-THF); the chain ether may specifically be, but is not limited to, one or more of dimethoxymethane (DMM), 1,2-dimethoxyethane (DME), and diethylene glycol dimethyl ether (TEGDME). The nitrile solvent may specifically be, but is not limited to, one or more of glutaronitrile and malononitrile. The carbonate solvent comprises a cyclic carbonate or a chain carbonate, wherein the cyclic carbonate may specifically be, but is not limited to, one or more of ethylene carbonate (EC), propylene carbonate (PC), gamma-butyrolactone (GBL), and butylene carbonate (BC); the chain carbonate may specifically be, but is not limited to, one or more of dimethyl carbonate (DMC), ethyl methyl carbonate (EMC), diethyl carbonate (DEC), and dipropyl carbonate (DPC). The carboxylate solvent may specifically be, but is not limited to, one or more of methyl acetate (MA), ethyl acetate (EA), propyl acetate, butyl acetate, propyl propionate (PP), and butyl propionate.

More preferably, the solvent comprises at least one of ethylene carbonate, propylene carbonate, butylene carbonate, dimethyl carbonate, diethyl carbonate, ethyl methyl carbonate, and propyl methyl carbonate.

Further, the positive electrode comprises a positive-electrode active material, wherein the positive-electrode active material is selected from at least one of LiNiₓCo_{y}Mn_{z}M_{1-x-y-z}O₂, LiCo_{1-y}M_{y}O₂, LiNi_{1-y}M_{y}O₂, LiMn_{2-y}M_{y}O₄, and LiFe_{1-x′}N_{x′}PO₄, wherein M is selected from at least one of Fe, Co, Ni, Mn, Mg, Cu, Zn, Al, Sn, B, Ga, Cr, Sr, V, or Ti, and 0≤y≤1, 0≤x≤1, 0≤z≤1, and x+y+z≤1; N is selected from at least one of Mn, Mg, Co, Ni, Cu, Zn, Al, Sn, B, Ga, Cr, Sr, V, or Ti, and 0≤x′<1.

Preferably, the positive-electrode active material is selected from at least one of LiCoO₂, LiNiO₂, LiMn₂O₄, LiFePO₄, LiFe_{0.2}Mg_{0.8}PO₄, LiFe_{0.4}CO_{0.6}PO₄, LiFe_{0.6}Ni_{0.4}PO₄, LiFe_{0.8}Cu_{0.2}PO₄, and LiFe_{0.7}Zn_{0.3}PO₄.

Further, the positive electrode further comprises a positive electrode current collector for leading out current, and the positive-electrode active material covers the positive electrode current collector.

Further, the negative electrode comprises a negative-electrode active material, and the negative-electrode active material may be made of a carbon material, a metal alloy, a lithium-containing oxide, and a silicon-containing material.

Further, the negative electrode further comprises a negative electrode current collector for leading out current, and the negative-electrode active material covers the negative electrode current collector.

Therefore, the lithium battery separator and the lithium battery provided by the present invention have the following beneficial effects:

According to the lithium battery separator and the lithium battery of the present invention, the block polymer is added, such that the separator also achieves the functions of the separator itself under the condition of a relatively small porosity, has good lithium-ion conduction characteristic, can reduce the thermal shrinkage rate of the separator, and improves the safety performance. Meanwhile, the lithium battery is prepared by matching the separator having the block polymer added with the electrolyte containing the cyclic carbonate, such that the low shrinkage of the separator and the high conductivity after the electrolyte is swelled are achieved, and the safety performance of the lithium battery is improved.

### DETAILED DESCRIPTION

The technical solutions of the present invention will be clearly and completely described below with reference to the specific examples, and it is obvious that the described examples are only a part of the examples of the present invention but not all of them. Based on the examples of the present invention, all other examples obtained by those of ordinary skill in the art without creative effort shall fall within the protection scope of the present invention.

### Example 1

### I. Preparation of Lithium Battery

### 1) Preparation of Separator

A PS-PEO-PS triblock polymer was prepared by adopting a free radical polymerization mode, wherein the weight average molecular weight of a rigid block PS block was 8 ten thousand, and the weight average molecular weight of a flexible block PEO block was 18 ten thousand. 50% of the block polymer and 50% of polyethylene were used as main materials, a separator was prepared using a dry method, and the porosity of the separator was controlled to be 20% by controlling the stretching degree in the preparation process.

### 2) Preparation of Positive Plate:

A positive-electrode active material lithium nickel cobalt manganese oxide LiNi_{0.5}Co_{0.2}Mn_{0.3}O₂, a conductive carbon black Super-P and a binder polyvinylidene fluoride (PVDF) were mixed in a mass ratio of 93:4:3, and then the resulting mixture was dispersed in N-methyl-2-pyrrolidone (NMP) to obtain a positive electrode slurry. Two surfaces of aluminum foil were uniformly coated with the slurry, followed by drying, calendering and vacuum drying, and welding an aluminum lead-out wire by using an ultrasonic welding machine to obtain a positive plate, with the thickness thereof being 120-150 μm.

### 3) Preparation of Negative Plate:

A negative-electrode active material artificial graphite, conductive carbon black Super-P, a binder styrene butadiene rubber (SBR) and carboxymethyl cellulose (CMC) were mixed in a mass ratio of 95:1:2.5:1.5, and then the resulting mixture was dispersed in deionized water to obtain a negative electrode slurry. Two surfaces of copper foil were coated with the slurry, followed by drying, calendering and vacuum drying, and welding a nickel lead-out wire by using an ultrasonic welding machine to obtain a negative plate, with the thickness thereof being 120-150 μm.

### 4) Preparation of Battery:

A separator having a thickness of 5 μm was placed between the positive plate and the negative plate, and then a sandwich structure consisting of the positive plate, the negative plate and the separator was subjected to winding, compression, liquid injection and sealing to obtain a lithium battery. The components of the electrolyte were as follows: EC:EMC:LiPF₆:VC:LiPO₂F₂=24:60:14:1:1.

### II. Performance Testing Method:

(1) Measurement of thermal shrinkage rate of separator: the separator prepared in Example 1 was placed at 140° C. for 30 min, the area of the separator before the test was S₀, the area of the separator after the test was Sₜ, and then the shrinkage rate of the separator was (1−Sₜ/S₀)×100%.

(2) Testing of ionic conductivity of separator: the prepared separator was soaked in an electrolyte for 30 min and then taken out, the electrolyte on the surface of the separator was wiped out by using dust-free paper, and the thickness b was measured by using a thickness meter. A 2025 button battery was prepared according to the sequence of positive electrode shell-shrapnel-stainless steel sheet-separator-stainless steel sheet-negative electrode shell, and 2 μL of electrolyte was added separately before and after the separator was placed. EIS testing was carried out on the button battery by using a solartron electrochemical workstation, wherein the measured ohmic internal resistance was R, the thickness of the separator was b, and the area of the separator was S, and then the calculation method for the ionic conductivity was that σ=b/(RS).

The test results are shown in Table 1.

### Examples 2-9

Examples 2-9 are used for illustrating the lithium battery separator of the present invention, including most of the operational steps of Example 1, and differ from Example 1 in that:

The values of the porosity p of the separator, the percentage w of the block polymer relative to the separator, and the mass percentage u of the cyclic carbonate relative to the electrolyte were different, and specific information and test results are shown in Table 1.

### Comparative Examples 1-4

Comparative Examples 1-4 are used for illustrating the lithium battery separator of the present invention, including most of the operational steps of Example 1, and differ from Example 1 in that:

The values of the porosity p of the separator, the mass percentage w of the block polymer relative to the separator, and the mass percentage u of the cyclic carbonate relative to the electrolyte were different, and specific information and test results are shown in Table 1.

TABLE 1
Separator and battery information and test results
of Examples 1-9 and Comparative Examples 1-4

| | | | | Mass | | |
|---|---|---|---|---|---|---|
| | Mass | | | percentage | | |
| | percentage | | | u of cyclic | Thermal | |
| | w of block | Porosity p | | carbonate | shrinkage | |
| | polymer | of | | relative to | rate of | Ionic |
| | relative to | separator/ | (1 − w)/3 | electrolyte/ | separator at | conductivity/ |
| Group | separator/% | % | Unit (%) | % | 140° C./% | S · cm⁻¹ |
| Example 1 | 50 | 20 | 16.7 | 25 | 15 | 5 × 10⁻³ |
| Example 2 | 50 | 18 | 16.7 | 25 | 14 | 4.2 × 10⁻³ |
| Example 3 | 50 | 22 | 16.7 | 25 | 15.5 | 5.3 × 10⁻³ |
| Example 4 | 50 | 23 | 16.7 | 25 | 15.8 | 5.7 × 10⁻³ |
| Example 5 | 70 | 23 | 10.0 | 25 | 13 | 6.7 × 10⁻³ |
| Example 6 | 100 | 23 | 0.0 | 25 | 11.5 | 7.5 × 10⁻³ |
| Example 7 | 100 | 22 | 0.0 | 25 | 10 | 7 × 10⁻³ |
| Example 8 | 50 | 20 | 16.7 | 16 | 15 | 4.5 × 10⁻³ |
| Example 9 | 50 | 20 | 16.7 | 30 | 15 | 6 × 10⁻³ |
| Comparative | 0 | 70 | 33.3 | 25 | 70 | 5.2 × 10⁻³ |
| Example 1 | | | | | | |
| Comparative | 50 | 3 | 16.7 | 25 | 5 | 1 × 10⁻⁴ |
| Example 2 | | | | | | |
| Comparative | 50 | 20 | 16.7 | 10 | 15 | 2 × 10⁻³ |
| Example 3 | | | | | | |
| Comparative | 50 | 20 | 16.7 | 5 | 15 | 1 × 10⁻³ |
| Example 4 | | | | | | |

As could be seen from the test results of Examples 1-7 and Comparative Examples 1-2, the block polymer was added to the separator, and the relationship between the content of the block polymer and the porosity of the separator was controlled, when the relationship satisfied that (1−w)/3<p<25%, the obtained separator could also achieve the functions of the separator itself at a low porosity, still had a high ionic conductivity, and could improve the safety performance of the lithium battery.

The ionic conductivity of the separator prepared in Example 1 was equivalent to that of the separator prepared in Comparative Example 1, but the porosity of the separator in Example 1 was far lower than that of the separator in Comparative Example 1, and the addition of the block polymer ensured a transmission channel of lithium ions at a lower porosity, and was more beneficial to effectively achieving the pore closure behavior of the separator under the possible problem of thermal runaway of the battery and improving the safety of the battery.

As could be seen from the test results of Examples 4-6, when the porosity of the separator was identical, the higher the content of the block polymer was, the smaller the thermal shrinkage rate of the separator was, and the higher the ionic conductivity was. As could be seen from the test results of Examples 1-4 and Comparative Example 2, when the content of the block polymer was identical, the separator had a low thermal shrinkage rate and a high ionic conductivity when the porosity satisfied that (1-w)/3<p<25%.

As could be seen from the test results of Examples 8-9 and Comparative Examples 3-4, the block polymer adsorbed the electrolyte by controlling the content of the cyclic carbonate in the electrolyte, thereby satisfying the transmission requirement for lithium ions. Meanwhile, the higher the content of the cyclic carbonate in the electrolyte was, the higher the ionic conductivity was; when the content of the cyclic carbonate was too low, the conductivity of the electrolyte itself was too low, resulting in a decrease in the conductivity of the separator.

### Examples 10-14

Examples 10-14 are used for illustrating the lithium battery separator of the present invention, including most of the operational steps of Example 1, and differ from Example 1 in that:

The weight average molecular weight of the flexible block A, the weight average molecular weight of the rigid block B, and the thickness d of the separator were different, and specific information and test results are shown in Table 2.

### Comparative Examples 5-8

Comparative Examples 5-8 are used for illustrating the lithium battery separator of the present invention, including most of the operational steps of Example 1, and differ from Example 1 in that:

The weight average molecular weight Wₐ of the flexible block A, the weight average molecular weight W_{b} of the rigid block B, and the thickness d of the separator were different, and specific information and test results are shown in Table 2.

TABLE 2
Separator and battery information and test results of
Examples 1, and 10-14 and Comparative Examples 5-8

| | | | | | | Thermal | |
|---|---|---|---|---|---|---|---|
| | | | | | | shrinkage | |
| | | | | | | rate of | Ionic |
| | | | | | | separator at | conductivity/ |
| Group | Wₐ | W_{b} | Wₐ/W_{b} | d | Wₐ/d | 140° C. | S · cm⁻¹ |
| Example 1 | 18 | 8 | 2.25 | 5 | 3.6 | 15 | 5 × 10⁻³ |
| Example 10 | 9 | 36 | 0.25 | 3 | 3 | 8 | 2.5 × 10⁻³ |
| Example 11 | 100 | 20 | 5 | 4 | 25 | 17 | 6.5 × 10⁻³ |
| Example 12 | 50 | 50 | 1 | 10 | 5 | 13 | 3 × 10⁻³ |
| Example 13 | 80 | 20 | 4 | 20 | 4 | 18 | 6.5 × 10⁻³ |
| Example 14 | 35 | 140 | 0.25 | 7 | 5 | 10 | 2.4 × 10⁻³ |
| Comparative | 12 | 100 | 0.12 | 3 | 4 | 7 | 0.1 × 10⁻³ |
| Example 5 | | | | | | | |
| Comparative | 80 | 10 | 8 | 15 | 5.3 | 27 | 6.7 × 10⁻³ |
| Example 6 | | | | | | | |
| Comparative | 20 | 80 | 0.25 | 20 | 1 | 8 | 0.5 × 10⁻³ |
| Example 7 | | | | | | | |
| Comparative | 90 | 78 | 1.15 | 3 | 30 | 23 | 3 × 10⁻³ |
| Example 8 | | | | | | | |

As could be seen from the test results of Examples 1 and 10-14 and Comparative Examples 5-8, when the weight average molecular weights of the flexible block A and the rigid block B in the block polymer satisfied that 0.25≤Wₐ/W_{b}≤5, the obtained separator could achieve both a good lithium ion transmission effect and good tensile strength. Meanwhile, the obtained separator had a high conductivity when the thickness of the separator and the weight average molecular weight of the flexible block A also satisfied that 3≤Wₐ/d≤25.

When Wₐ/W_{b} did not satisfied that 0.25≤Wₐ/W_{b}≤5, a phase-separated structure of the block polymer could not be effectively formed. When Wₐ/W_{b} was <0.25, the content of the flexible block in the block polymer decreased, and a block phase throughout the thickness range of the separator could not be formed, resulting in a sharp decrease in the ionic conductivity. As the Wₐ/W_{b} ratio increased, a phase-separated structure of the block polymer was formed, and meanwhile, the content of the block polymer portion that could participate in lithium-ion conduction increased due to the increase in the content of the flexible block, resulting in an increase in the ionic conductivity.

When Wₐ/W_{b} was >5, the content of the rigid block greatly decreased, a phase-separated structure of the block polymer could not be effectively formed, and thus the rigid block could not effectively support the framework of the separator, resulting in a significant increase in the thermal shrinkage rate.

The best condition for the separator to function was that the block polymer had obvious phase separation, wherein the dimension of the flexible block A separation phase was in the same order of magnitude with the thickness of the separator, such that the block A could form a communicated conductive path in the direction throughout the thickness of the separator. Specifically, when it was satisfied that 3≤Wₐ/d≤25, the ionic conductivity and the shrinkage rate of the separator were both at a superior level. When Wₐ/d was <3, the dimension of the flexible block A was much smaller than the thickness of the separator, and thus an ion path with a shorter path could not be formed, resulting in a significant decrease in the ionic conductivity. When Wₐ/d was >25, the dimension of the flexible block phase was much larger than the thickness of the separator, and thus the rigid block in the block polymer could not effectively support the structure of the separator, resulting in a significant increase in the thermal shrinkage rate.

### Examples 15-22

Examples 15-22 are used for illustrating the lithium battery separator of the present invention, including most of the operational steps of Example 1, and differ from Example 1 in that:

The structural formulas of the flexible block A and the rigid block B were different, the specific information is shown in Table 3, and the test results are shown in Table 4.

### Comparative Examples 9-11

Comparative Examples 9-11 are used for illustrating the lithium battery separator of the present invention, including most of the operational steps of Example 1, and differ from Example 1 in that:

The structural formulas of the flexible block A and the rigid block B were different, the specific information is shown in Table 3, and the test results are shown in Table 4.

TABLE 3
Separator information of Examples 15-22 and
Comparative Examples 9-11

| | |
|---|---|
| 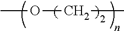 | Structural formula A1 |
| 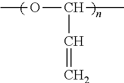 | Structural formula A2 |
| 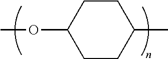 | Structural formula A3 |
| 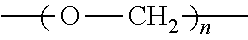 | Structural formula A4 |
| 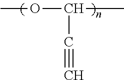 | Structural formula A5 |
| 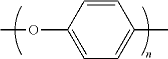 | Structural formula A6 |
| 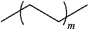 | Structural formula B1 |
| 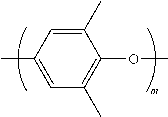 | Structural formula B2 |
| 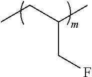 | Structural formula B3 |
| 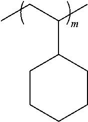 | Structural formula B4 |
| 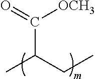 | Structural formula B5 |
| 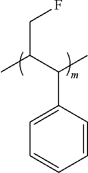 | Structural formula B6 |

TABLE 4
Test results of Examples 15-22 and Comparative Examples 9-11

| | | | Thermal | |
|---|---|---|---|---|
| | Structural | Structural | shrinkage | |
| | formula of | formula of | rateof | Ionic |
| | flexible | rigid | separator at | conductivity/ |
| Group | block A | block B | 140° C./% | S · cm⁻¹ |
| Example 15 | Structural | Structural | 25 | 5.1 × 10⁻³ |
| | formula A1 | formula B1 | | |
| Example 16 | Structural | Structural | 23 | 4.2 × 10⁻³ |
| | formula A2 | formula B1 | | |
| Example 17 | Structural | Structural | 19 | 2.5 × 10⁻³ |
| | formula A3 | formula B1 | | |
| Example 18 | Structural | Structural | 14 | 5.5 × 10⁻³ |
| | formula A1 | formula B2 | | |
| Example 19 | Structural | Structural | 23 | 5.2 × 10⁻³ |
| | formula A1 | formula B3 | | |
| Example 20 | Structural | Structural | 18 | 5.4 × 10⁻³ |
| | formula A1 | formula B4 | | |
| Example 21 | Structural | Structural | 20 | 5.5 × 10⁻³ |
| | formula A1 | formula B5 | | |
| Example 22 | Structural | Structural | 17 | 4.7 × 10⁻³ |
| | formula A1 | formula B6 | | |
| Comparative | Structural | Structural | 40 | 1.1 × 10⁻³ |
| Example 9 | formula A4 | formula B1 | | |
| Comparative | Structural | Structural | 35 | 0.8 × 10⁻³ |
| Example 10 | formula A5 | formula B1 | | |
| Comparative | Structural | Structural | 30 | 0.2 × 10⁻³ |
| Example 11 | formula A6 | formula B1 | | |

As could be seen from the test results of Examples 15-22 and Comparative Examples 9-11, when specific structural formulas of the flexible block A and the rigid block B in the block polymer were respectively selected, the flexible block A and the rigid block B could achieve phase separation well, and the obtained separator could achieve both a good lithium ion transmission effect and good tensile strength.

The present invention is further described above with reference to specific embodiments, but it should be understood that the specific description herein should not be construed as limiting the spirit and scope of the present invention, and that various modifications to the above embodiments made by those of ordinary skill in the art upon reading the specification fall within the protection scope of the present invention.

1. A lithium battery separator, wherein the separator contains a block polymer, a porosity of the separator is p, a mass percentage of the block polymer relative to the separator is w, and a relationship between the mass percentage w of the block polymer relative to the separator and the porosity p of the separator satisfies that (1−w)/3<p<25%.

2. The lithium battery separator according to claim 1, wherein the mass percentage w of the block polymer relative to the separator is >40%.

3. The lithium battery separator according to claim 1, wherein the block polymer comprises a flexible block A and a rigid block B, a structure of the block polymer is AₙBₘ, AₙBₘAₙ, or BₘAₙBₘ, and a weight average molecular weight Wₐ of the flexible block A and a weight average molecular weight W_{b} of the rigid block B satisfy that 0.25≤Wₐ/W_{b}≤5.

4. The lithium battery separator according to claim 3, wherein the weight average molecular weight Wₐ of the flexible block A satisfies that 8≤Wₐ≤100 in unit of ten thousand; the weight average molecular weight W_{b} of the rigid block B satisfies that 10≤W_{b}≤150 in unit of ten thousand.

5. The lithium battery separator according to claim 4, wherein a thickness d of the separator satisfies that 3≤d≤20 in unit of μm; the weight average molecular weight Wₐ of the flexible block A and the thickness d of the separator satisfy that 3≤Wₐ/d≤25.

6. The lithium battery separator according to claim 3, wherein a structural formula of the flexible block A is as follows: 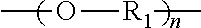
wherein R₁ is hydrocarbyl having a degree of unsaturation of not more than 1, and a molecular weight W₁ of R₁ satisfies that 28≤W₁≤108;
a structural formula of the rigid block B is as follows: 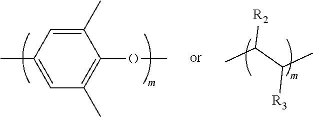
wherein R₂ is one of hydrogen, hydrocarbyl or halohydrocarbyl having a molecular weight of not more than 45, and a saturated ester group;
R₃ is one of hydrogen, hydrocarbyl or halohydrocarbyl having a molecular weight of not more than 45, cyclic unsaturated hydrocarbyl, and aliphatic hydrocarbyl.

7. The lithium battery separator according to claim 1, wherein a surface of the separator is further coated with ceramic powder or polymer glue; the ceramic powder comprises one or more of aluminum oxide and boehmite; the polymer glue comprises one or more of PVDF, PMMA, and PAN.

8. A lithium battery, comprising a positive electrode, a negative electrode, an electrolyte, and the separator according to claim 1.

9. The lithium battery according to claim 8, wherein the electrolyte comprises a cyclic carbonate.

10. The lithium battery according to claim 9, wherein a mass percentage u of the cyclic carbonate relative to the electrolyte is >15%, and the cyclic carbonate is selected from any one or more of ethylene carbonate, propylene carbonate, fluoroethylene carbonate, vinylene carbonate, and difluoroethylene carbonate
